(19) United States
(12) Patent Application Publication
(10) Pub. No.: US 2011/0246067 A1
(43) Pub. Date: Oct. 6, 2011

(54) SYSTEM AND METHOD FOR DYNAMIC ROUTING

(75) Inventors: Thomas Stephen Markham, Schenectady, NY (US); Patricia Denise Mackenzie, Clifton Park, NY (US); Joseph James Salvo, Schenectady, NY (US); Roman Brusilovsky, Clifton Park, NY (US); Daniel John Messier, Albany, NY (US)

(73) Assignee: GENERAL ELECTRIC COMPANY, SCHENECTADY, NY (US)

(21) Appl. No.: 12/749,550

(22) Filed: Mar. 30, 2010

(51) Int. Cl. G01C 21/36; G06Q 10/00; G08G 1/0969; G06F 15/18

(52) U.S. Cl. 701/210; 701/200; 701/207; 701/213; 706/12

(57) ABSTRACT

A dynamic routing system includes a data collection module, a static routing module, an orientation module, a learning module, and a route determination module. The data collection module receives real time trip data corresponding to a moving asset from a remote location, and the static routing module determines candidate routes from a source to a destination for the moving asset. The orientation module is configured to gather publically available information associated with candidate routes, and the learning module is configured to generate a learned route database based on the publically available information from the orientation module and the real time trip data from the data collection module. The route determination module determines an optimized route for the moving asset based on the learned route database. The system further includes a communication interface configured to transmit an optimized route signal.

### BACKGROUND

The invention relates generally to a dynamic routing system and method for moving assets and, more specifically, to the use of real time data analysis for dynamic routing of moving assets.

As the world's economies become more and more interdependent, efficient distribution of goods becomes useful for many businesses that depend on such distribution. Goods are often distributed from central locations to many retail destinations. Efficient distribution of goods entails, among other things, a determination of routes and schedules for the fleet of vehicles so that total distribution costs are minimized, while various constraints are met.

Distributors or planners generally allocate resources such as trailers and drivers to deliver goods on time. When delivery delays occur, it is difficult to analyze whether any alternative actions could have prevented or reduced such delays. As the number of drivers and trailers grows for a particular fleet, coordination challenges increase. Currently, human dispatchers and drivers who have a knack for scheduling and planning use their knowledge for vehicle trip scheduling and routing. Computer software is sometimes used for in route optimization to select shorter or faster routes. However, these methods are not efficient or comprehensive enough to track all factors that may result in delay.

There is a need for an improved, automated transportation system.

### BRIEF DESCRIPTION

In accordance with an embodiment of the present invention, a dynamic routing system comprising a data collection module for receiving real time trip data corresponding to a moving asset from a remote location is provided. The system further includes a static routing module to determine candidate routes from a source to a destination for the moving asset and an orientation module configured to gather publically available information associated with candidate routes. A learning module configured to generate a learned route database based on the publically available information from the orientation module and on the real time trip data from the data collection module is also provided in the system. The system also includes a route determination module to determine an optimized route for the moving asset based on the learned route database and a communication interface configured to transmit an optimized route signal.

In accordance with another embodiment of the present invention, a method for identifying dynamic routing for a moving asset is provided. The method includes receiving real time trip data corresponding to the moving asset and determining candidate routes from a source to a destination for the moving asset. The method also includes obtaining publically available information associated with candidate routes and generating a learned route database based on candidate routes and the publically available information. The method further includes estimating an optimized route for the moving asset based on the learned route database.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a trailer system with a simplified communication system in accordance with an embodiment of the invention;

FIG. 2 is a schematic representation of an dynamic routing system in accordance with an embodiment of the present invention; and

FIG. 3 is a pictorial view of an example output of a dynamic routing system in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

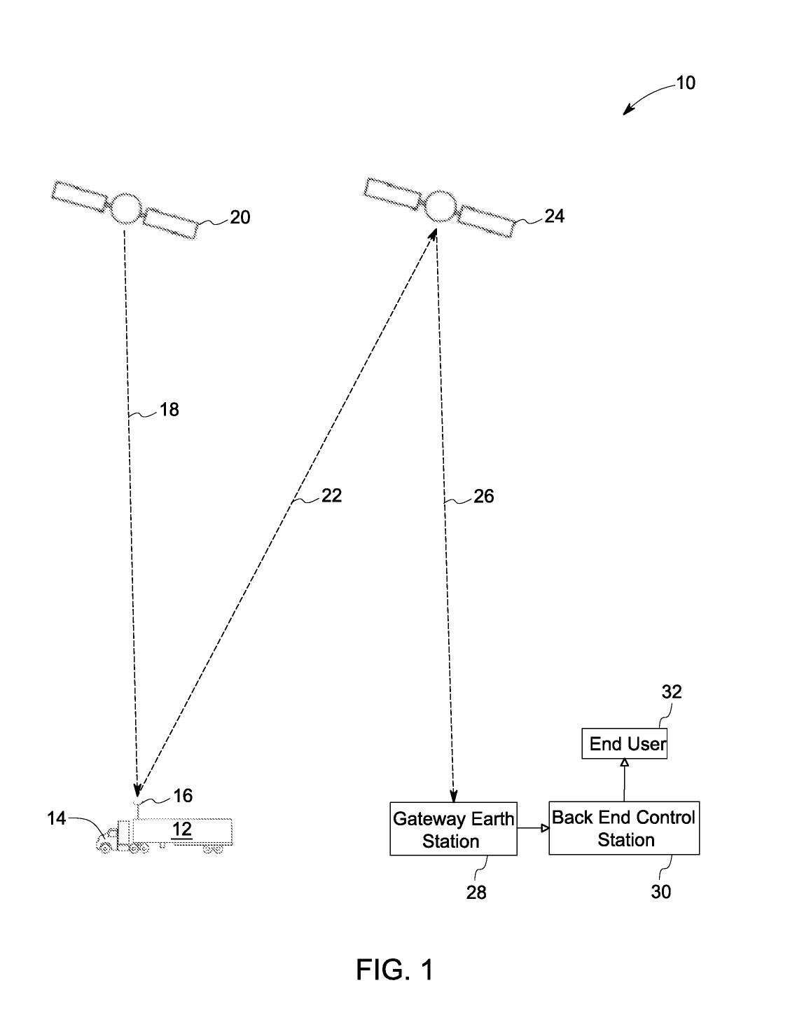

FIG. 1 is a schematic illustration of a trailer system 10 with a simplified communication system. The trailer system 10 includes a trailer 12 carrying goods and a cab 14 attached to a front end of trailer 12. Although the illustrated embodiment shows a trailer, other types of vehicles such as railcars, intermodal containers, flatbeds, refrigerated units, delivery vans, sales vehicles, emergency response vehicles, or passenger vehicles, for example, may be employed. A remote hub 16 is located in trailer 12 in one embodiment. In another embodiment, the remote hub may be located inside cab 14. Remote hub 16 is configured to receive wireless signals 18 about location information via a location tracking device 20. In one example, the location tracking device 20 comprises a global positioning satellite (GPS). In another embodiment, the location information may be provided by a non-satellite source such as a WiFi access point, cellular tower, or other fixed wireless nodes. Remote hub 16 further transmits wireless signals 22 to a data communication device 24 such as a data satellite. Remote hub 16 may also transmit data about the trailer that it received from either wired or wireless sensors. It should be noted that in one embodiment a mobile/cellular tower may alternatively be used. The remote hub 16 may additionally transmit wireless signals to cab 14 to relay information received via wireless signals 18 and 22 respectively. One example of such a remote hub 16 is a telematic hub.

When data communication device 24 comprises a data satellite, the data satellite transmits a wireless signal 26 received from remote hub 16 to a gateway earth station 28. Wireless signal 26 transmitted by remote hub 16 may comprise information such as trailer location data, a corresponding time-stamp, trailer ignition data, trailer identification data, and combinations thereof. It may also comprise event data such as ‘trip start’, ‘trip end’, ‘door open’, ‘door close’, ‘cargo loaded’, and ‘cargo empty,’ for example. It may also include other sensor data such as tire pressure, anti-lock brake status, bearing vibration. Gateway earth station 28 is generally controlled by the satellite network provider. Data received from the data communication device through the Gateway earth station is processed by a back end control station 30. Back end control station 30 processes the data, which may include use of additional information such as internet data for performing data analytics, and then delivers the results such as asset location or optimized route to the end customer 32, either through the web or a direct data feed such as XML data exchange. In one embodiment, the end customer may be a driver.

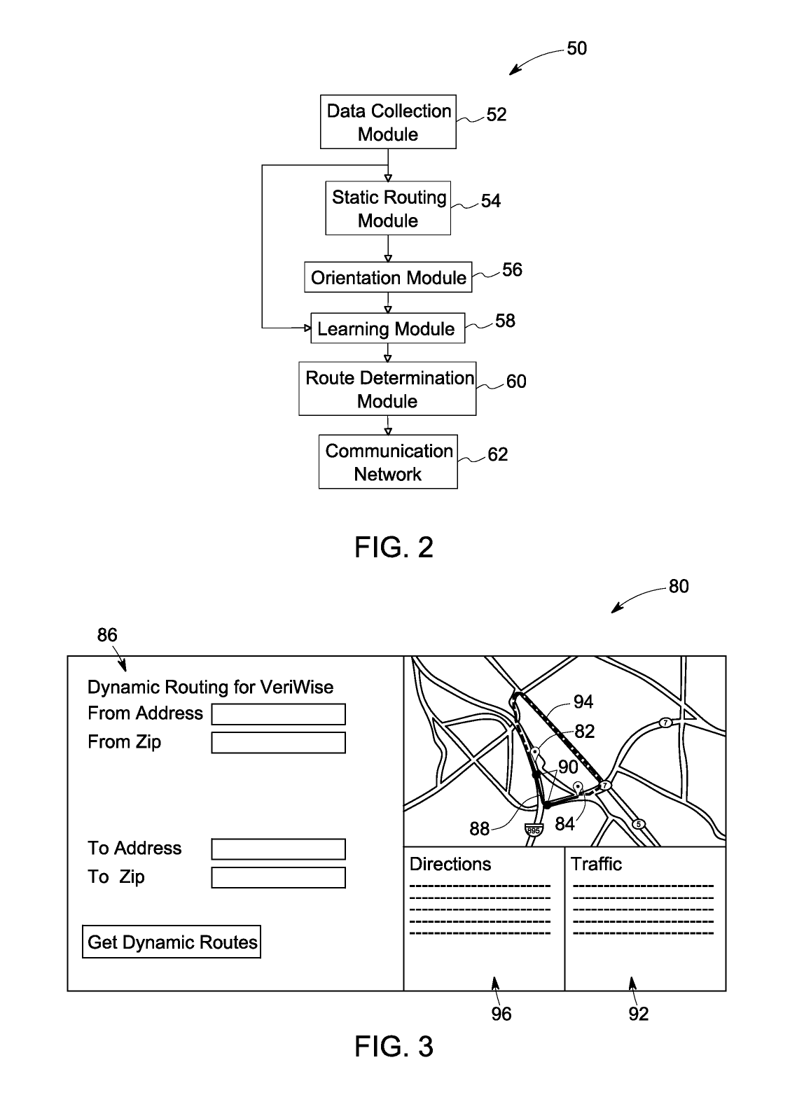

FIG. 2 is a schematic illustration of one embodiment of a dynamic routing system 50. System 50 includes a data collection module 52, a static routing module 54, an orientation module 56, a learning module 58, a route determination module 60, and a communication network 62. In one embodiment, data collection module 52 may comprise a wireless transmitter device configured to obtain real time trip data related to a truck or a trailer. Additionally, the data collection module may be configured with location-indicating capabilities. Thus, the data collection module may indicate current location, time, and a transportation route. The data collection module may operate as a satellite-based system, a wireless Internet system, a radio frequency (RF) system, or any other suitable communication system. The data collection module further comprises a data collection device to obtain a routing data from a moving asset. In one embodiment, the routing data comprises information that is useful for determining an optimized route from a source A to a destination B. In one embodiment, the source A may be the current location of the moving asset. It should be noted that the most optimized route may be vehicle or driver specific with several examples including the route which will need the least travel time and a route which has least fuel prices on the road.

Static routing module 54 determines candidate routes from the source to the destination for the routing data received from the data collection module. In one embodiment, static routing module 54 may include a map database such as Google Maps mapping service, MapQuest Inc mapping service, Yahoo! Map mapping service, or Environmental Systems Research Institute (ESRI) mapping service. Static routing module 54 further provides candidate routes to orientation module 56 for determining obstacles or disturbances on candidate routes. For example, if static routing module 54 receives information from data collection module 52 that a trailer A is at location X and need to go to a location Y, then static routing module 54 provides routes along the X to Y path to orientation module 56.

Orientation module 56 collects publically available information about the candidate routes and real time trip data from data collection module 52 and provides it as an input signal to learning module 58. In one embodiment, data collection module 52 may directly provide the real time trip data to learning module 58. The publically available information may include traffic conditions, road conditions, weather conditions, community events, department store sale or event conditions, concert or sporting event information, and fuel prices on the candidate routes, for example. The publically available information may further include information such as shipment departures from a local distribution center on the candidate route. The real time trip data may comprise data such as status of an anti-lock braking system for the moving asset or speed of the moving asset or delay in travel time to reach the destination or even information about a road construction on a candidate route. It may also comprise event data such as ‘trip start’, ‘trip end’, ‘door open’, ‘door close’, ‘cargo loaded’, and ‘cargo empty,’ for example.

Learning module 58 generates a learned route database based on the information from orientation module 56. The learning module may include predictors which enable route determination module 60 to better select optimal routes, based on the output of the predictors. In one embodiment, the predictor predicts delays on certain candidate routes based on obvious and non-obvious events obtained from the orientation module.

The obvious events may comprise information such as time of day, day of week, season, weather, and direction of travel. In one embodiment, the predictor may provide an indicator to avoid certain candidate routes or certain direction of travel on the candidate routes based on the time of day. For example, over time the predictor may have learned or the historical data may suggest that during morning time, a candidate route A has heavy traffic compared to the evening time. Thus, the predictor will give indication to avoid candidate route A during morning time. The predictor may utilize other obvious events such as slow movement of another vehicle being monitored by the dynamic routing system and output a warning of traffic jams or lane closures on a particular candidate route.

The non-obvious event may comprise information such as status (activation) of Anti-lock braking system of a moving asset combined with the trailer's location on a candidate route and the temperature or precipitation likelihood on the route. The predictor will then predict and output a warning of an icy road on that candidate route if the anti-lock braking system status is active and temperature is low or precipitation is high. Further, if the predictor senses traffic issues in a certain area, it will mine all the data input to the system to determine if there is correlation over time with other (seemingly unrelated) activities, such as shipment departure times from a local distribution center. Thus, in the future, if the predictor knows shipments are planned from that local distribution center, it will forecast potential issues and automatically alert a warning about the particular candidate route. In one embodiment, a less obvious predictor may be point of sale volume from a retailer center that would predict either increased traffic volume on access roads leaving that center or forecast increased traffic activity at the local distribution center within the next 24 hours window. It should be noted that the events mentioned above are only exemplary and similar other examples may be utilized to correlate various activities and to forecast obstacles on candidate routes. Thus, learning module 58 stores historical trip data of various trailers on a given route, analyzes the data and forecasts traffic conditions based on the analysis.

Route determination module 60 utilizes candidate routes and mashes them with the information from the orientation module and the output of predictors and determines the optimal routes for the moving asset. For example, the route determination module avoids all candidate routes on which warnings are sounded by predictors and selects an optimized route on which least travel time will be achieved. In one embodiment, route determination module 60 splits the route in multiple segments and checks whether there are any barriers on those segments based on the information from the learning module and then it determines an optimal route around the barrier. In one embodiment, route determination module 60 will determine a route which will result in least fuel price. Once an optimized route is identified, a communication network 62 communicates it to the respective user or the moving asset. For example, the communication network may send a real time signal to a driver to take the optimized route.

FIG. 3 shows an example output 80 of the dynamic routing system. An optimal route between a source 82 and a destination 84 is asked to the system in the left hand side box 86. Static routing module 54 (FIG. 2) identifies a route 88 as the candidate route. However, learning module 58 (FIG. 2) determines that there are multiple barriers 90 on candidate route 88. The barriers are listed on bottom right hand side box 92. Route determination module 60 (FIG. 2) determines an optimal route 94 which would avoid barriers 90 and would be the one which will result in least travel time. The directions of the optimal route are then provided in another output box 96.

One of the advantages of the dynamic routing system is it allows efficient planning in the transportation sector of the supply chain. The dynamic routing system finds potential real time inefficiencies in the distribution system based on the status of predictors and suggest improvements. The dynamic routing system may be used to drive decisions for simple routing and also may learn from previous dynamic routing results so as to create models to explain the behavior and use these models to forecast optimal future routes based on the status of various predictors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A dynamic routing system comprising:
a data collection module for receiving real time trip data corresponding to a moving asset from a remote location;
a static routing module for determining candidate routes from a source to a destination for the moving asset;
an orientation module configured to gather publically available information associated with candidate routes;
a learning module configured to generate a learned route database based on the publically available information from the orientation module and on the real time trip data from the data collection module;
a route determination module to determine an optimized route for the moving asset based on the learned route database; and
a communication interface configured to transmit an optimized route signal.

2. The system of claim 1, further comprising a satellite source or a non-satellite source for transmitting position data to the moving asset

3. The system of claim 2, wherein the satellite source comprises a global positioning satellite.

4. The system of claim 2, wherein the non-satellite source comprises a WiFi access point, cellular tower, or other fixed wireless nodes.

5. The system of claim 1, wherein the moving asset comprises a trailer, a railcar, an intermodal container, flatbed, refrigerated unit, a delivery van, a sales vehicle, emergency response vehicle or a passenger vehicle.

6. The system of claim 1, wherein the static routing module comprises a map database.

7. The system of claim 6, wherein the map database comprises Google Maps mapping service, MapQuest Inc. mapping service, Yahoo! Map mapping service, or Environmental Systems Research Institute (ESRI) mapping service.

8. The system of claim 1, wherein the optimized route comprises a route with least travel time or a route with least fuel prices.

9. The system of claim 1, wherein the publically available information may comprises at least one of traffic conditions, road conditions, weather conditions, road construction information, and fuel prices on the candidate routes.

10. The system of claim 1, wherein the learning module comprises a predictor configured to output a warning on candidate routes based on obvious and non-obvious events.

11. The system of claim 10, wherein obvious events comprise at least one of time of day, day of week, season, direction of travel, and weather.

12. The system of claim 11, wherein the predictor is configured to predict delay during a time of day depending on historical data.

13. The system of claim 10, wherein obvious events further comprise slow movement of another vehicle being monitored by the dynamic routing system.

14. The system of claim 13, wherein the learning module comprises a traffic jam or lane closure predictor when the obvious event is slow movement of another vehicle being monitored by the dynamic routing system.

15. The system of claim 10, wherein the non-obvious events comprise anti-lock braking system status of the moving asset, point of sale volume from a retailer center, shipment departure from a local distribution center, local community events, department store sale or event conditions, and concert or sporting event information.

16. The system of claim 15, wherein the predictor is configured to predict icy road conditions if the anti-lock braking system status is active and temperature is low or precipitation is high.

17. The system of claim 15, wherein the predictor is configured to predict traffic delays for non-obvious events comprising at least one of a shipment departure from a local distribution center or a point of sale volume from a retailer center.

18. The system of claim 1, wherein the learning module is configured to store and analyze historical trip data and to forecast traffic conditions based on the analysis of the historical trip data.

19. A method for identifying dynamic routing for a moving asset comprising:
receiving real time trip data corresponding to the moving asset;
determining candidate routes from a source to a destination for the moving asset;
obtaining publically available information associated with candidate routes;
generating a learned route database based on candidate routes and the publically available information; and
estimating an optimized route for the moving asset based on the learned route database.
